(19) United States
(12) Patent Application Publication
(10) Pub. No.: US 2025/0386275 A1
(43) Pub. Date: Dec. 18, 2025

(54) LOW LATENCY PROCESSING FOR WIFI OR WIRELESS NETWORKS AND ROUTERS

(71) Applicant: Charter Communications Operating, LLC, St. Louis, MO (US)

(72) Inventors: Charles Cook, Castle Rock, CO (US); Sebnem Ozer, Perkasie, PA (US)

(73) Assignee: Charter Communications Operating, LLC, St. Louis, MO (US)

(21) Appl. No.: 18/745,646

(22) Filed: Jun. 17, 2024

(51) Int. Cl. H04W 40/06; H04W 40/28

(52) U.S. Cl. CPC H04W 40/06; H04W 40/28

(57) ABSTRACT

Methods and systems for enabling low latency processing in routers which provide and support wireless access and communications. A method for enabling low latency processing in wireless routers includes providing, by a wireless router, a wireless network name and a low latency wireless network name, receiving, by the wireless router from a wireless device, low latency data packets using the low latency wireless network name, receiving, by the wireless router from the wireless device, unmarked data packets using the wireless network name, prioritizing, by a low latency scheduler engine in the wireless router, processing of the low latency data packets over the unmarked data packets, and sending, by the wireless router, the processed low latency data packets prior to sending the processed unmarked data packets.

### TECHNICAL FIELD

This disclosure relates to wireless communications. More specifically, this disclosure relates to enabling low latency processing at routers which support wireless transmission or communications and/or wireless routers.

### BACKGROUND

Telecommunications service providers provide cable, television, Internet, voice, data, and other services (collectively “services”) to a customer by deploying equipment at the customer's premises and connecting the equipment back to the service provider's central office or system via an access network. One such piece of equipment is a router and/or wireless router, which provides wireless access to wireless devices at the customer premises, and supports wireless transmissions and/or communications between the wireless devices and the router, and communications eventually to service provider system and destination. Data packets can be transmitted or sent between the wireless devices, the router, and the service provider system. Increasingly, applications that run on the wireless devices, such as but not limited to, gaming, interactive web, interactive video, instant messaging, virtual reality, augmented reality, and/or remote control of devices, prefer that the data packets be sent with low latency, low delay, and/or low loss (collectively referred to herein as “low latency data packets” and also referred to as “low latency traffic”) in contrast to classic data packets.

Traffic communications between the wireless devices and the routers can often be a bottleneck in trying to provide low latency services. This can occur, in part, because the wireless devices and routers manage resource unit blocks to maximize throughput. The wireless devices and routers load a resource block with incoming data packets irrespective of low latency. Therefore, low latency data packets may need to wait along with classic data packets until the wireless devices and routers determine that the resource block is sufficiently full or maximized and can be transmitted. Accordingly, these wireless devices and routers lack mechanisms to handle data packets that prefer low latency.

### SUMMARY

Disclosed herein is a system and method for enabling low latency processing in routers which provide and support wireless access and communications. In implementations, a method for enabling low latency processing in wireless routers includes providing, by a wireless router, a wireless network name and a low latency wireless network name, receiving, by the wireless router from a wireless device, low latency data packets using the low latency wireless network name, receiving, by the wireless router from the wireless device, unmarked data packets using the wireless network name, prioritizing, by a low latency scheduler engine in the wireless router, processing of the low latency data packets over the unmarked data packets, and sending, by the wireless router, the processed low latency data packets prior to sending the processed unmarked data packets.

### BRIEF DESCRIPTION OF THE DRAWINGS

The disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 is a diagram of an example of a wireless network architecture with traffic flow from consumer to system in accordance with embodiments of this disclosure.

FIG. 1A is a diagram of an example of a wireless network architecture with traffic flow from consumer to system in accordance with embodiments of this disclosure.

FIG. 2 is a diagram of an example of a wireless network architecture with traffic flow from system to consumer in accordance with embodiments of this disclosure.

FIG. 3 is a diagram of another example of a wireless network architecture with traffic flow from consumer to system in accordance with embodiments of this disclosure.

FIG. 4 is a diagram of another example of a wireless network architecture with traffic flow from system to consumer in accordance with embodiments of this disclosure.

FIG. 5 is a flowchart of an example method for low latency processing in accordance with embodiments of this disclosure.

FIG. 6 is a flowchart of another example method for low latency processing in accordance with embodiments of this disclosure.

FIG. 7 is a flowchart of another example method for low latency processing in accordance with embodiments of this disclosure.

FIG. 8 is a block diagram of an example of a device in accordance with embodiments of this disclosure.

### DETAILED DESCRIPTION

Reference will now be made in greater detail to embodiments of the invention, examples of which are illustrated in the accompanying drawings. Wherever possible, the same reference numerals will be used throughout the drawings and the description to refer to the same or like parts.

As used herein, the terminology “server”, “computer”, “computing device or platform”, or “cloud computing system” includes any unit, or combination of units, capable of performing any method, or any portion or portions thereof, disclosed herein. For example, the “server”, “computer”, “computing device or platform”, or “cloud computing system” may include at least one or more processor(s).

As used herein, the terminology “processor” or “processing circuitry” indicates one or more processors, such as one or more special purpose processors, one or more digital signal processors, one or more microprocessors, one or more controllers, one or more microcontrollers, one or more application processors, one or more central processing units (CPU) s, one or more graphics processing units (GPU) s, one or more digital signal processors (DSP) s, one or more application specific integrated circuits (ASIC) s, one or more application specific standard products, one or more field programmable gate arrays, any other type or combination of integrated circuits, one or more state machines, or any combination thereof.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory and hardware that is hard-wired into the processing circuitry.

As used herein, the terminology “memory” indicates any computer-usable or computer-readable medium or device that can tangibly contain, store, communicate, or transport any signal or information that may be used by or in connection with any processor. For example, a memory may be one or more read-only memories (ROM), one or more random access memories (RAM), one or more registers, low power double data rate (LPDDR) memories, one or more cache memories, one or more semiconductor memory devices, one or more magnetic media, one or more optical media, one or more magneto-optical media, or any combination thereof.

As used herein, the term “memory” includes one or more memories, where each memory may be a computer-readable medium. A memory may encompass memory hardware units (e.g., a hard drive or a disk) that store data or instructions in software form. Alternatively or in addition, the memory may include data or instructions that are hard-wired into processing circuitry. The memory may include a single memory unit or multiple joint or disjoint memory units, which each of the multiple joint or disjoint memory units storing all or a portion of the data described as being stored in the memory.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. For example, the memory can be non-transitory. Instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the term “application” refers generally to a unit of executable software that implements or performs one or more functions, tasks, or activities. For example, applications may perform one or more functions including, but not limited to, telephony, web browsers, e-commerce transactions, media players, scheduling, management, smart home management, entertainment, and the like. The unit of executable software generally runs in a predetermined environment and/or a processor.

As used herein, the terminology “determine” and “identify,” or any variations thereof includes selecting, ascertaining, computing, looking up, receiving, determining, establishing, obtaining, or otherwise identifying or determining in any manner whatsoever using one or more of the devices and methods are shown and described herein.

As used herein, the terminology “example,” “the embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “or” is intended to mean an inclusive “or” rather than an exclusive “or.” That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

As used herein, unless explicitly stated otherwise, any term specified in the singular may include its plural version. For example, “a computer that stores data and runs software,” may include a single computer that stores data and runs software or two computers—a first computer that stores data and a second computer that runs software. Also “a computer that stores data and runs software,” may include multiple computers that together stored data and run software. At least one of the multiple computers stores data, and at least one of the multiple computers runs software.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure and claims. Although aspects, features, and elements are described herein in particular combinations, each aspect, feature, or element may be used independently or in various combinations with or without other aspects, features, and elements.

Further, the figures and descriptions provided herein may be simplified to illustrate aspects of the described embodiments that are relevant for a clear understanding of the herein disclosed processes, machines, and/or manufactures, while eliminating for the purpose of clarity other aspects that may be found in typical similar devices, systems, and methods. Those of ordinary skill may thus recognize that other elements and/or steps may be desirable or necessary to implement the devices, systems, and methods described herein. However, because such elements and steps do not facilitate a better understanding of the disclosed embodiments, a discussion of such elements and steps may not be provided herein. However, the present disclosure is deemed to inherently include all such elements, variations, and modifications to the described aspects that would be known to those of ordinary skill in the pertinent art in light of the discussion herein.

Described herein is a system and method for enabling low latency processing in wireless networks. In implementations, a router can use or provide two service set identifiers (SSIDs) for an associated wireless or Wi-Fi network, where one SSID is used for low latency data packets or non-queue-building data (referred to as a “SSID LL”) and another SSID is used for classic data packets, non-low latency data packets, or queue-building data. The terms non-queue-building data and queue-building data refer to how the router and a wireless device(s) using the wireless or Wi-Fi network use resource block size and usage. The router and wireless device(s) can process or handle queue-building data to maximize throughput and can process or handle non-queue-building data to reduce or minimize latency. The router and wireless device(s) can maximize throughput by usage of relatively larger resource blocks in contrast to minimizing latency by usage of relatively smaller resource blocks.

In implementations, the router and wireless device(s) can include a low latency scheduler engine which can intake marked data packets and unmarked data packets, where marked data packets indicate low latency data packets. In implementations, the low latency scheduler engine can be a Low Latency, Low Loss, and Scalable throughput (L4S) engine and protocol as described in Internet Engineering Task Force (IETF) RFC 9330 entitled “Low Latency, Low Loss, and Scalable Throughput (LAS) Internet Service: Architecture”, published on January 2023, and described in Internet Engineering Task Force (IETF) RFC 9331 entitled “The Explicit Congestion Notification (ECN) Protocol for Low Latency, Low Loss, and Scalable Throughput (L4S)”, published on January 2023, the contents of each are herein incorporated by reference in their entireties as if set forth herein. In implementations, a data packet can be marked by setting an Explicit Congestion Notification (ECN) field in the IP header of the data packet. In implementations, a data packet can be marked using other fields in the IP header. In implementations, a data packet can be marked by setting an appropriate value in a Differentiated Services Code Point (DSCP) field in a data packet. For example, a high priority value can support low latency or real-time dependent transmissions. In implementations, a data packet can be marked by setting congestion experience (CE) codepoint bits during congestion per the L4S specifications. In implementations, a data packet can be marked using a combination of the fields described herein.

In implementations, a low latency scheduler engine at a sending device, such as the wireless device or the router, can process or handle marked data packets by prioritizing them or by providing precedence based on latency over unmarked data packets. That is, the marked data packets can be processed ahead of unmarked data packets using the smallest appropriate resource blocks. In implementations, prioritization may refer to the providing of required differentiated quality of service (QoS) targets, e.g., consistent low latency for low latency traffic or data flows, even when, for example, a wireless or Wi-Fi priority level may be best effort. In implementations, unmarked data packet processing can be stalled (assuming that transmission of the unmarked data packet has not started) to permit marked data packet processing. The processed marked data packets can be transmitted using the SSID LL. A low latency scheduler engine at a receiving device, such as the router or the wireless device, can prioritize handling of the marked data packets.

In implementations, data packets can be marked by an application generating the data packets. For instance, the application can be running on the wireless device. The marked data packets are then processed by the low latency scheduler engine as described herein. In implementations, the wireless device or router can include a deep packet inspective device or engine which inspects content in the data packets and marks the data packets, if appropriate. The marked data packets are then processed by the low latency scheduler engine as described herein. In implementations, the wireless device can include an analyzer or engine which reviews network information, such as but not limited to, port numbers, data packet arrival times, data packet size, and transport protocol, to mark the data packets as appropriate if the application has non-responsive low-latency traffic, where the term “non-responsive” refers to traffic and/or data which is sent without requiring an acknowledgment. For example, User Datagram Protocol (UDP) traffic is a form of non-responsive traffic whereas Transmission Control Protocol (TCP) traffic requires an acknowledgement. The marked data packets are then processed by the low latency scheduler engine as described herein. In implementations, the deep packet inspective device or engine and/or the analyzer or engine can be configured by the service provider system for the non-responsive low-latency traffic or a proxy system may exist for L4S type traffic.

In implementations, a marking entity, i.e., a content provider, an application, an analyzer in a wireless device, and/or an analyzer in a router can mark using designated fields. In an illustrative example, the analyzer in a wireless device, the application, and/or the content provider can set an appropriate value in a DSCP field. In an illustrative example, an ECN field can be set by the application or content provider. In an illustrative example, the router can mark congestion experience (CE) codepoint bits during congestion per the L4S specifications.

In implementations, the sending device and/or the receiving device can include a single radio or radio frequency (RF) unit to transmit and/or receive, respectively, the data packets. In this instance, the appropriate low latency scheduler engine and/or other components in the sending device and/or the receiving device can schedule use of the single radio or radio frequency (RF) unit such that the SSID LL traffic is prioritized over other SSIDs. In implementations, the sending device and/or the receiving device can include multiple radios or RF units at different frequencies to transmit and/or receive, respectively, the data packets. In this instance, one of the multiple radios or RF units can be aligned with the SSID LL or marked data packets and another of the multiple radios or RF units can be aligned with the SSID or unmarked data packets. In this instance, the appropriate low latency scheduler engine and/or other components in the sending device and/or the receiving device can send the data packets accordingly and appropriately.

In implementations, the system and method minimizes latency issues by using the low latency scheduler engine and protocols, appropriately sized resource blocks, and multiple SSIDs.

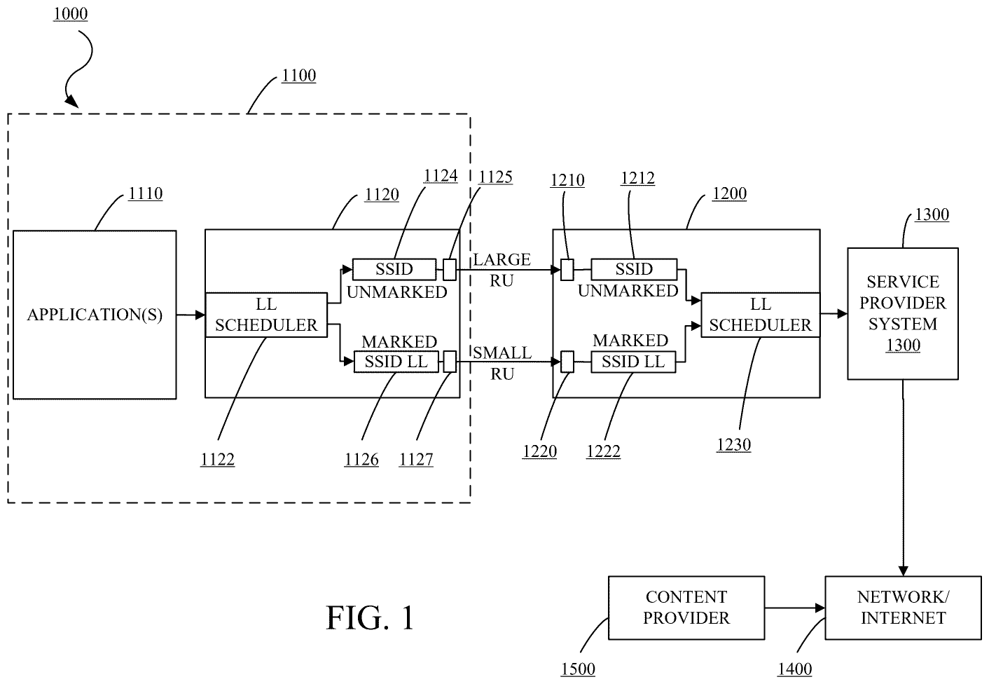

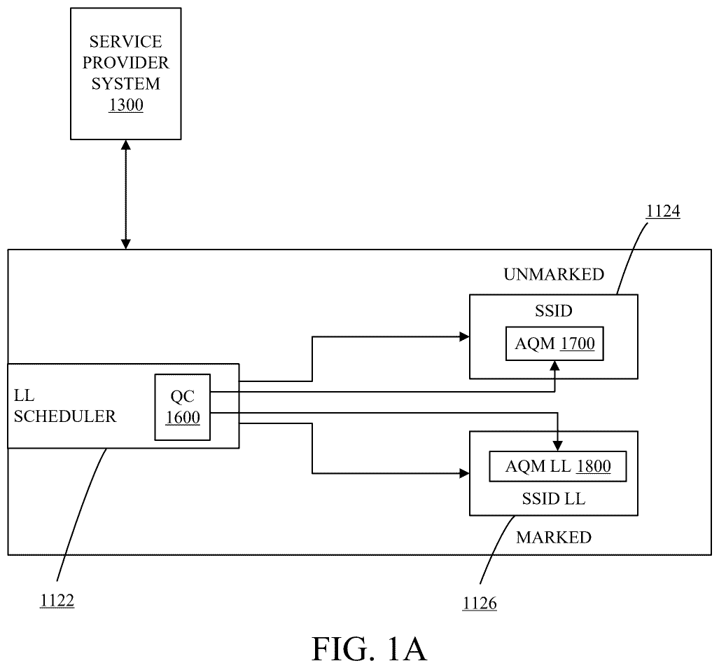

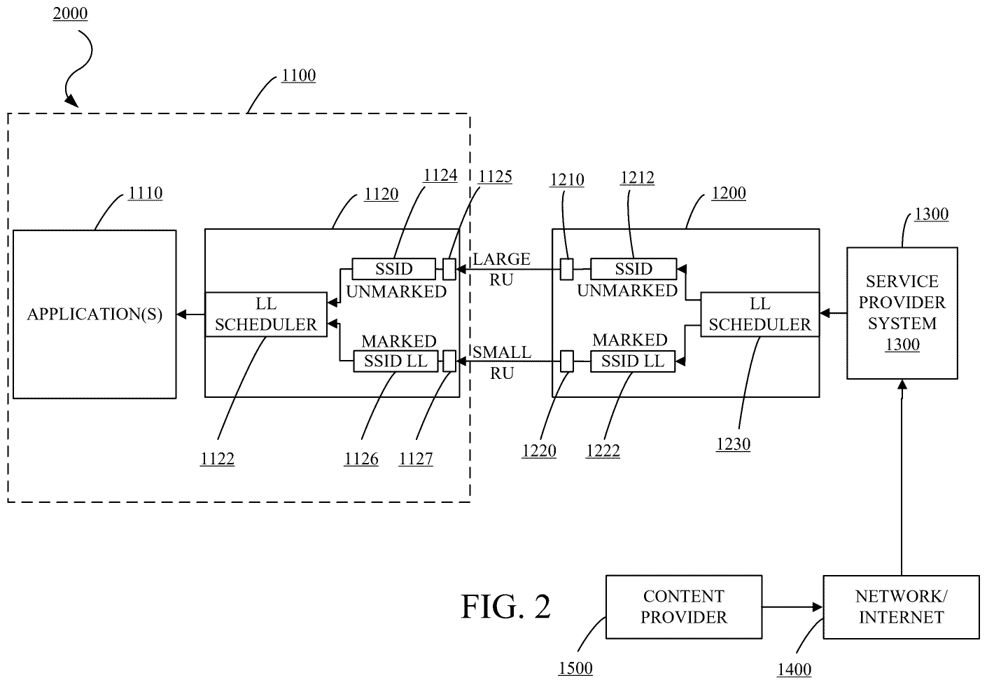

FIG. 1 is a diagram of an example of a wireless network architecture 1000 with traffic flow from consumer to system in accordance with embodiments of this disclosure, and FIG. 2 is a diagram of an example of the wireless network architecture 1000 with traffic flow from system to consumer in accordance with embodiments of this disclosure. The wireless network architecture 1000 can include, but is not limited to, one or more wireless devices 1100, a router 1200 which provides wireless access and communications to one or more wireless devices 1100, a service provider 1300, and a network/Internet 1400. The wireless network architecture 1000 can include, but is not limited to, wireless networks, WiFi networks, and/or wireless local area networks (WLAN). The number of components shown in the wireless network architecture 1000 are illustrative and there may be more or less in the wireless network architecture 1000. The wireless network architecture 1000 and the components therein may include other elements which may be desirable or necessary to implement the devices, systems, and methods described herein. However, because such elements and steps do not facilitate a better understanding of the disclosed embodiments, a discussion of such elements and steps may not be provided herein.

The one or more wireless devices 1100 can be, but is not limited to, Internet of Thing (IoT) devices, sensors, end user devices, cellular telephones, Internet Protocol (IP) devices, mobile computers, laptops, handheld computers, personal media devices, smartphones, notebooks, notepads, and the like, which can be provisioned for operation with the router 1200. Each wireless device 1100 can include one or more applications 1110 and a transmit and receive unit (TRU) 1120

In implementations, the one or more applications 1110 can be any type or variety of applications including applications requiring or preferring low latency processing. The one or more applications 1110 can mark data packets requiring or preferring low latency processing. In implementations, an ECN field of the IP header, a DSCP field, and/or combinations thereof can be marked as appropriate.

The TRU 1120 can include a LL scheduler or engine 1122, an unmarked or SSID circuity path 1124 connected to a radio or RF unit 1125, and a marked or SSID LL circuity path 1126 connected to a radio or RF unit 1127. In implementations, the LL scheduler or engine 1122 can be a scheduler or engine which can process unmarked and marked data packets for further processing via the appropriate unmarked or SSID circuity path 1124 and the radio or RF unit 1125, or the marked or SSID LL circuity path 1126 and the radio or RF unit 1127, respectively. In implementations, as further described with respect to FIG. 1A, the LL scheduler 1122 can include a queue controller (QC) 1600 as a closed feedback controller, which can be connected to an active queue management (AQM) component 1700 in the SSID circuity path 1124 and to an AQM LL component 1800 in the SSID LL circuity path 1126, to ensure LL traffic is non-queue building and that marked and unmarked traffic share the medium fairly in terms of both traffic requirements. Although shown with respect to the LL scheduler 1122, the QC 1600, the AQM component 1700, and AQM LL component 1800 are applicable to each of the implementations described herein.

In implementations, the radio or RF unit 1125 and the radio or RF unit 1127 can be the same radio or RF unit. In implementations, the radio or RF unit 1125 and the radio or RF unit 1127 can operate on different frequencies or spectra. In implementations, the radio or RF unit 1125 can operate on one of 2.4 GHz, 5.0 GHz, or 6.0 GHz and the radio or RF unit 1127 can operate on a remaining one of 2.4 GHz, 5.0 GHz, or 6.0 GHz.

The router 1200 can provide and support wired and/or wireless access and communications and/or can be a wireless router. The router 1200 can include a LL scheduler or engine 1230, an unmarked or SSID circuity path 1212 connected to a radio or RF unit 1210, and a marked or SSID LL circuity path 1222 connected to a radio or RF unit 1220. In implementations, the LL scheduler or engine 1230 can be a L4S scheduler or engine which can process unmarked and marked data packets for further processing via the appropriate unmarked or SSID circuity path 1212 and the radio or RF unit 1210 or the marked or SSID LL circuity path 1222 and the radio or RF unit 1220, respectively.

In implementations, the radio or RF unit 1210 and the radio or RF unit 1220 can be the same radio or RF unit. In implementations, the radio or RF unit 1210 and the radio or RF unit 1220 can operate on different frequencies or spectra. In implementations, the radio or RF unit 1210 can operate on one of 2.4 GHz, 5.0 GHz, or 6.0 GHz and the radio or RF unit 1220 can operate on a remaining one of 2.4 GHz, 5.0 GHz, or 6.0 GHz.

The service provider system 1300 can include various functional components to address functions with respect to, for example, the router 1200. The service provider system 1300 can include, but is not limited to, a coaxial cable system, a Passive Optical Network (PON) system, an optical system, and their respective operations support system (OSS).

The network and/or Internet 1400 can be, but is not limited to, the Internet, an intranet, a local area network (LAN), a wide area network (WAN), a public network, a private network, a cellular network, a WiFi-based network, a telephone network, a landline network, public switched telephone network (PSTN), a wireless network, a wired network, a private branch exchange (PBX), an Integrated Services Digital Network (ISDN), a IP Multimedia Services (IMS) network, a Voice over Internet Protocol (VoIP) network, and like including any combinations thereof to reach a destination device and/or application.

Operationally, the router 1200 provides a wireless network or wireless coverage area which is indicated by transmission of the SSID, which can be visible to users of the wireless devices 1100. The SSID LL is also transmitted but does not have to be visible. In implementations, the SSID LL can be transmitted and be visible. The wireless device 1100 can be associated with both the SSID and the SSID LL. As appropriate and needed, the one or more applications 1110 can mark low latency data packets using a field in the IP header and/or another field in the data packet. In implementations, the ECN field in the IP header can be used for marking or identifying purposes.

In implementations, the radio or RF unit 1125 and the radio or RF unit 1127 are a single radio and transmission of packets is performed serially through the TRU 1120. If there is one physical radio, the transmission of the streams is serial because the same transmission resource is used. The data packets, including both marked data packets and unmarked data packets, can be processed by the LL scheduler 1122. The LL scheduler 1122 can review, recognize, and process the marked data packets and unmarked data packets. The LL scheduler 1122 can direct the unmarked data packets to the unmarked or SSID circuity path 1124 and the marked data packets to the marked or SSID LL circuity path 1126. The LL scheduler 1122 and/or the unmarked or SSID circuity path 1124 can process unmarked data packets using resource unit blocks to maximize throughput. For instance, larger size resource unit blocks can be used to make efficient of transmission resources. However, this can delay transmission of low latency data packets as the larger size resource unit blocks need to be sufficiently packed before being transmitted. Accordingly, the LL scheduler 1122 and/or the marked or SSID LL circuity path 1126 can process marked data packets using appropriately sized or smaller resource unit blocks to reduce latency issues. Although these smaller size resource unit blocks are not throughput efficient, they can be transmitted substantially without delay or nearly immediately. The LL scheduler 1122 can prioritize processing and transmission of the marked data packets as opposed to the unmarked data packets. That is, the marked data packets are first in queue for processing prior to unmarked data packets. In other words, SSID LL associated data packets are given preference over SSID associated data packets. In implementations, the LL scheduler 1122 can stall processing of unmarked data packets if there are marked data packets that need to be processed. This can occur as long as the unmarked data packets are not in the transmission process, in which case processing of the marked data packets can take place after transmission of the unmarked data packets. The LL scheduler 1122 can return to processing of unmarked data packets after processing of the marked data packets is complete. The radio or RF unit 1125 and the radio or RF unit 1127 can transmit the unmarked data packets and the marked data packets.

Referring now also to FIG. 1A, as stated above, the LL scheduler 1122 can include a QC 1600 in cooperation with a AQM component 1700 and a AQM component LL 1800. The LL scheduler 1122 can monitor queue size and latency information from the AQM component 1700 and the AQM LL component 1800 to ensure the quality of service for both marked LL and unmarked traffic. The QC 1600 can detect when L4S marked traffic flow does not scale back to congestion as required by IETF RFC 9330. The QC 1600 can also detect if non-L4S LL (unmarked) traffic exceeds the rate requirements specified in “A Non-Queue-Building Per-Hop Behavior (NQB PHB) for Differentiated Services”, draft-ietf-tsvwg-nqb-23, and dated May 20, 2024. In this case, the LL scheduler 1122 can send the misbehaving traffic to the SSID 1124 where the unmarked traffic is transmitted. The LL scheduler 1122 and/or the QC 1600 can also detect if unmarked traffic transmission is starved or the quality of service requirements of the unmarked traffic are not met due to the precedence given to the LL traffic (marked traffic). In this case, the LL scheduler 1122 can adjust the parameters of the AQM component 1700 and the AQM LL component 1800 and media access parameters and scheduling of marked and unmarked traffic to corresponding SSIDs, i.e., the SSID circuity path 1124 and the SSID LL circuity path 1126, to optimize the performance of all traffic. The LL scheduler 1122 can employ machine learning and/or other techniques to make decisions based on additional monitored metrics and knowledge-based data.

In implementations, the system and components therein can be employed for different radio and spectrum deployments. For example, the system and components therein can be defined per shared resources and processing units. Therefore, the same system and components can be used for different deployment architectures, e.g., when the TRU share the same radio or RF unit or when the TRU has two different radio or RF units. In implementations, to achieve a single implementation platform, the LL scheduler 1122 can be initiated with a configuration process from, for example, the service provider system 1300, via application programming interfaces.

The wireless device 1100 transmitted data packets can be received by the router 1200. The unmarked data packets can be received by or at the radio or RF unit 1210 and processed via the unmarked or SSID circuity path 1212. The marked data packets can be received by or at the radio or RF unit 1220 and processed via the marked or SSID LL circuity path 1222. In implementations, the radio or RF unit 1210 and the radio or RF unit 1220 can be one radio or RF unit or different radio or RF units. Buffers in the router 1200, the unmarked or SSID circuity path 1212, the marked or SSID LL circuity path 1222, and/or the LL scheduler 1230 can buffer the data packets including the unmarked data packets and the marked data packets, as appropriate, for processing by the LL scheduler 1230. The LL scheduler 1230 can prioritize processing of the marked data packets over the unmarked data packets. In other words, traffic arriving over the SSID LL is given preference over traffic arriving over SSID. In implementations, the LL scheduler 1230 may aggregate arriving data packets. In this instance, the LL scheduler 1230 can prioritize the marked data packets over the unmarked data packets. Accordingly, the LL scheduler 1230 can send and/or transmit the marked data packets to the network/Internet 1400 via the service provider system 1300 and then send and/or transmit the unmarked data packets to the network/Internet 1400 via the service provider system 1300.

In implementations, the radio or RF unit 1125 and the radio or RF unit 1127 are two radios and transmission of packets is performed in parallel through the TRU 1120. As described herein, the radio or RF unit 1125 and the radio or RF unit 1127 can operate on different frequency bands so that the two radios do not interfere with each other. In this case, the marked traffic can be transmitted over SSID LL using a small resource unit via the SSID LL circuity path 1126 and the radio or RF unit 1127 without waiting for the completion of the transmission of unmarked traffic using a large resource unit via the SSID circuity path 1124 and the radio or RF unit 1125. The parallel implementation can further reduce latency over the serial implementation.

The data packets, including both marked data packets and unmarked data packets, can be processed by the LL scheduler 1122. The LL scheduler 1122 can review, recognize, and process the marked data packets and unmarked data packets. The LL scheduler 1122 can direct the unmarked data packets to the unmarked or SSID circuity path 1124 and the marked data packets to the marked or SSID LL circuity path 1126. The LL scheduler 1122 and/or the unmarked or SSID circuity path 1124 can process unmarked data packets using resource unit blocks to maximize throughput. The LL scheduler 1122 and/or the SSID LL circuity path 1126 can process marked data packets using resource unit blocks to minimize latency. The appropriate ones of the radio or RF unit 1125 and the radio or RF unit 1127 can transmit the unmarked data packets and the marked data packets, respectively, as applicable. The transmitting of the marked data packets and unmarked data packets can be done nearly or substantially simultaneously using the appropriate ones of the radio or RF unit 1125 and the radio or RF unit 1127.

The wireless device 1100 transmitted data packets can be received by the router 1200. The unmarked data packets can be received by or at the radio or RF unit 1210 and processed via the unmarked or SSID circuity path 1212. The marked data packets can be received by or at the radio or RF unit 1220 and processed via the marked or SSID LL circuity path 1222. In implementations, the radio or RF unit 1210 and the radio or RF unit 1220 can be one radio or RF unit or different radio or RF units. In implementations, the radio or RF unit 1210 and the radio or RF unit 1220 can be one radio or RF unit or different radio or RF units. Buffers in the router 1200, the unmarked or SSID circuity path 1212, the marked or SSID LL circuity path 1222, and/or the LL scheduler 1230 can buffer the data packets including the unmarked data packets and the marked data packets, as appropriate, for processing by the LL scheduler 1230. The LL scheduler 1230 can prioritize processing of the marked data packets over the unmarked data packets. In other words, traffic arriving over the SSID LL is given preference over traffic arriving over SSID. In implementations, the LL scheduler 1230 may aggregate the arriving data packets. In this instance, the LL scheduler 1230 can prioritize the marked data packets over the unmarked data packets. Accordingly, the LL scheduler 1230 can send and/or transmit the marked data packets to the network/Internet 1400 via the service provider system 1300 and then send and/or transmit the unmarked data packets to the network/Internet 1400 via the service provider system 1300.

Now referring also to FIG. 2, in a return and/or reverse direction, the network/Internet 1400 or a content provider 1500 connected to the network/Internet 1400 can mark data packets as described herein for low latency applications. The remainder of the processing is similar to that described with respect to FIG. 1.

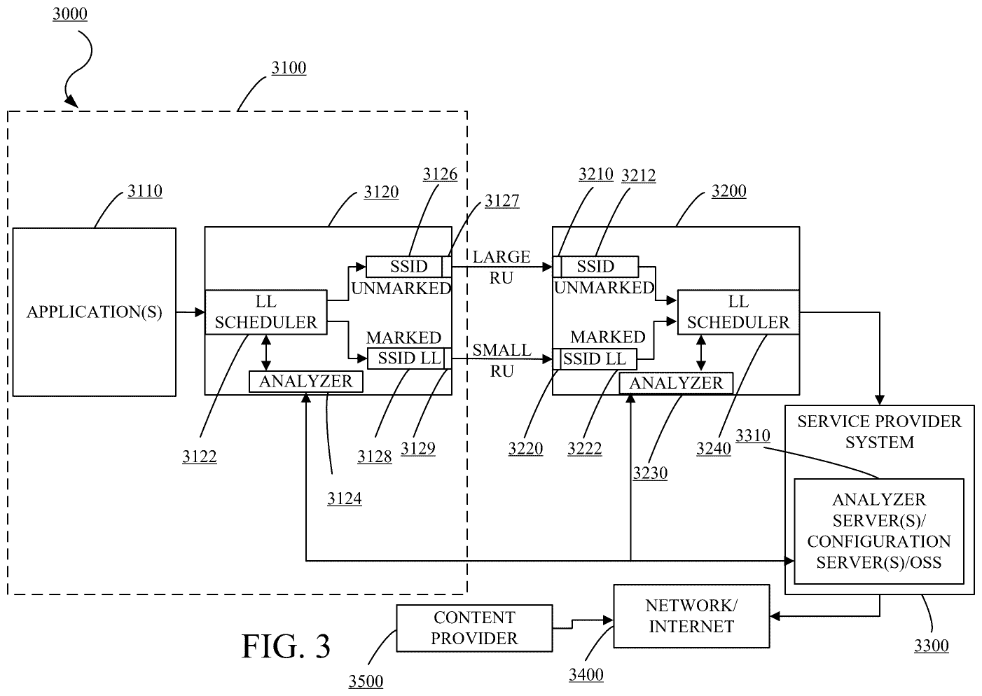

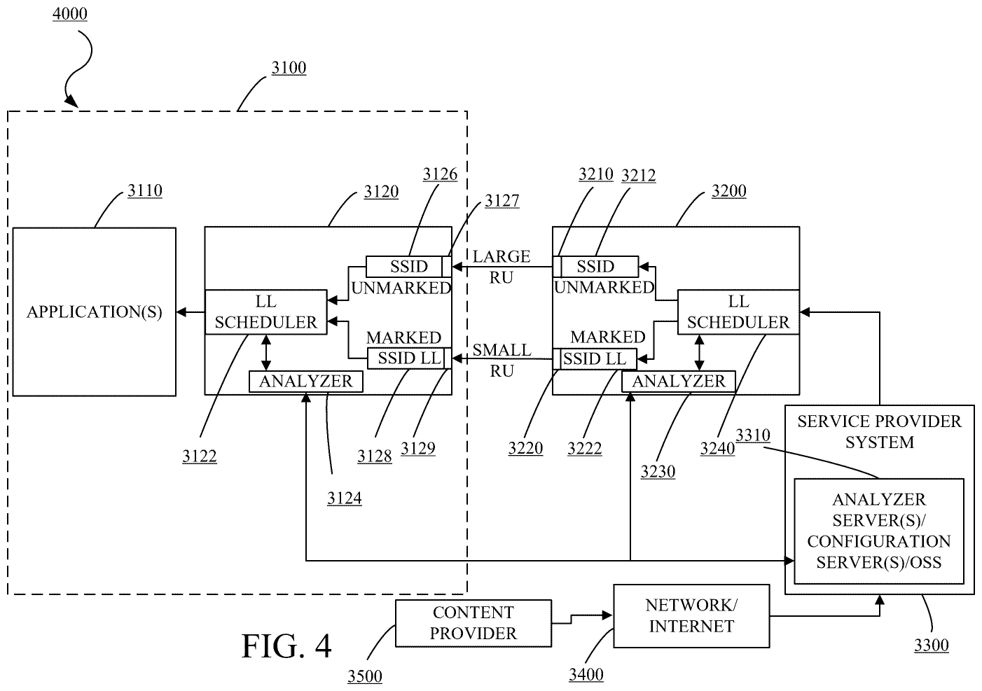

FIG. 3 is a diagram of another example of a wireless network architecture 3000 with traffic flow from consumer to system in accordance with embodiments of this disclosure and FIG. 4 is a diagram of the example wireless network architecture 3000 with traffic flow from system to consumer in accordance with embodiments of this disclosure. The wireless network architecture 3000 can include, but is not limited to, one or more wireless devices 3100, a router 3200 which provides wireless access and communications to the one or more wireless devices 3100, a service provider 3300, and a network/Internet 3400. The wireless network architecture 3000 can include, but is not limited to, wireless networks, WiFi networks, and/or wireless local area networks (WLAN). The number of components shown in the wireless network architecture 3000 are illustrative and there may be more or less in the wireless network architecture 3000. The wireless network architecture 3000 and the components therein may include other elements which may be desirable or necessary to implement the devices, systems, and methods described herein. However, because such elements and steps do not facilitate a better understanding of the disclosed embodiments, a discussion of such elements and steps may not be provided herein.

The one or more wireless devices 3100 can be, but is not limited to, Internet of Thing (IoT) devices, sensors, end user devices, cellular telephones, Internet Protocol (IP) devices, mobile computers, laptops, handheld computers, personal media devices, smartphones, notebooks, notepads, and the like, which can be provisioned for operation with the router 3200. Each wireless device 3100 can include one or more applications 3110 and a transmit and receive unit (TRU) 3120.

In implementations, the one or more applications 3110 can be any type or variety of applications including applications requiring or preferring low latency processing.

The TRU 3120 can include a LL scheduler or engine 3122, a packet analyzer or engine 3124, an unmarked or SSID circuity path 3126 connected to a radio or RF unit 3127, and a marked or SSID LL circuity path 3128 connected to a radio or RF unit 3129. In implementations, the LL scheduler or engine 3122 can be a L4S scheduler or engine which can process unmarked and marked data packets for further processing via the appropriate unmarked or SSID circuity path 3126 and the radio or RF unit 3127 or the marked or SSID LL circuity path 3128 and the radio or RF unit 3129, respectively.

In implementations, the radio or RF unit 3127 and the radio or RF unit 3129 can be the same radio or RF unit. In implementations, the radio or RF unit 3127 and the radio or RF unit 3129 can operate on different frequencies or spectra. In implementations, the radio or RF unit 3127 can operate on one of 2.4 GHz, 5.0 GHz, or 6.0 GHz and the radio or RF unit 3129 can operate on a remaining one of 2.4 GHz, 5.0 GHz, or 6.0 GHz.

In implementations, the packet analyzer or engine 3124 can detect, review, and/or determine whether data packets arriving from the one or more application(s) 3110 are data packets associated with low latency applications. In implementations, the packet analyzer or engine 3124 can be a deep packet inspective device or engine which inspects content in the data packets and marks the data packets accordingly. In implementations, the packet analyzer or engine 3124 can review network information, such as but not limited to, port numbers, data packet arrival times, data packet size, and transport protocol, to mark the data packets as appropriate. In implementations, a type of service (ToS) or traffic class (TC) field of the IP header can be marked by the packet analyzer or engine 3124, as appropriate, for further processing by the wireless device 3100, the LL scheduler or engine 3122, the unmarked or SSID circuity path 3126 and the radio or RF unit 3127, and/or the marked or SSID LL circuity path 3128 and the radio or RF unit 3129, as appropriate. In implementations, the ToS and/or TC can include DSCP, ECN, and/or other bits.

The router 3200 can provide and support wired and/or wireless access and communications and/or can be a wireless router. The router 3200 can include a LL scheduler or engine 3240, a packet analyzer or engine 3230, an unmarked or SSID circuity path 3221 connected to a radio or RF unit 3210 (unmarked circuit), and a marked or SSID LL circuity path 3222 connected to a radio or RF unit 3220 (marked or low latency circuit). In implementations, the radio or RF unit 3210 and the radio or RF unit 3220 can be the same radio or RF unit. In implementations, the LL scheduler or engine 3240 can be a L4S scheduler or engine which can process unmarked and marked data packets for further processing via the appropriate unmarked or SSID circuity path 3212 and the radio or RF unit 3210, or the marked or SSID LL circuity path 3222 and the radio or RF unit 3220, respectively.

In implementations, the radio or RF unit 3210 and the radio or RF unit 3220 can operate on different frequencies or spectra. In implementations, the radio or RF unit 3210 can operate on one of 2.4 GHz, 5.0 GHz, or 6.0 GHz and the radio or RF unit 3220 can operate on a remaining one of 2.4 GHz, 5.0 GHz, or 6.0 GHz.

In implementations, the packet analyzer or engine 3230 can detect, review, and/or determine whether data packets arriving from the network/Internet 3400 via the service provider system 3300 are data packets associated with low latency applications. In implementations, the packet analyzer or engine 3230 can be a deep packet inspective device or engine which inspects content in the data packets and marks the data packets accordingly. In implementations, the packet analyzer or engine 3230 can review network information, such as but not limited to, port numbers, data packet arrival times, data packet size, and transport protocol, to mark the data packets as appropriate. In implementations, an ECN field of the IP header can be marked by the packet analyzer or engine 3230, as appropriate, for further processing by the router 3200, the LL scheduler or engine 3240, the unmarked or SSID circuity path 3212 and the radio or RF unit 3210, and/or the marked or SSID LL circuity path 3222 and the radio or RF unit 3220, as appropriate.

The service provider system 3300 can include various functional components to address functions with respect to, for example, the router 3200. The service provider system 3300 can include, but is not limited to, an analyzer server(s), configuration server(s), and/or operations support system (OSS) configured to provide instructions and/or control information to the router 3200, the wireless device 3100, the packet analyzer or engine 3124, and/or the packet analyzer or engine 3230. In implementations, the instructions and/or control information can be instructive of what data or information to review to determine if the data packets are low latency packets, come from low latency applications, and/or are for low latency applications.

The network and/or Internet 3400 can be, but is not limited to, the Internet, an intranet, a local area network (LAN), a wide area network (WAN), a public network, a private network, a cellular network, a WiFi-based network, a telephone network, a landline network, public switched telephone network (PSTN), a wireless network, a wired network, a private branch exchange (PBX), an Integrated Services Digital Network (ISDN), a IP Multimedia Services (IMS) network, a Voice over Internet Protocol (VoIP) network, and like including any combinations thereof to reach a destination device and/or application.

Operationally, the router 3200 provides a wireless network or wireless coverage area which is indicated by transmission of the SSID, which can be visible to users of the wireless devices. The SSID LL is also transmitted but does not have to be visible. In implementations, the SSID LL can be transmitted and be visible. The wireless device 3100 can be associated with both the SSID and the SSID LL.

The data packets can be processed by the LL scheduler 3122 and the packet analyzer or engine 3124. The packet analyzer or engine 3124 can detect, review, and/or determine whether the data packets from the one or more application(s) 3110 are data packets associated with low latency applications. The packet analyzer or engine 3124 can mark the data packets using a field in the IP header and/or another field in the data packet. In implementations, the ECN field in the IP header can be used for marking or identifying purposes.

The LL scheduler 3122 can review, recognize, and process the marked data packets and unmarked data packets. The LL scheduler 3122 can direct the unmarked data packets to the unmarked or SSID circuity path 3126 and the marked data packets to the marked or SSID LL circuity path 3128. The LL scheduler 3122 and/or the unmarked or SSID circuity path 3126 can process unmarked data packets using resource unit blocks to maximize throughput. For instance, larger size resource unit blocks can be used to make efficient of transmission resources.

However, this can delay transmission of low latency data packets as the larger size resource unit blocks need to be sufficiently packed before being transmitted. Accordingly, the LL scheduler 3122 and/or the marked or SSID LL circuity path 3128 can process marked data packets using appropriately sized or smaller resource unit blocks to reduce latency issues. Although these smaller size resource unit blocks are not throughput efficient, they can be transmitted substantially without delay or nearly immediately. The LL scheduler 3122 can prioritize processing and transmission of the marked data packets as opposed to the unmarked data packets. That is, the marked data packets are first in queue for processing prior to unmarked data packets. In other words, SSID LL associated data packets are given preference over SSID associated data packets. In implementations, the LL scheduler 3122 can stall processing of unmarked data packets if there are marked data packets that need to be processed. This can occur as long as the unmarked data packets are not in the transmission process, in which case processing of the marked data packets can take place after transmission of the unmarked data packets. The LL scheduler 3122 can return to processing of unmarked data packets after processing of the marked data packets is complete. The appropriate ones of the radio or RF unit 3127 and the radio or RF unit 3129 can transmit the unmarked data packets and the marked data packets, respectively, as applicable.

The wireless device 3100 transmitted data packets can be received by the router 3200. The unmarked data packets can be received by or at the radio or RF unit 3210 and processed via the unmarked or SSID circuity path 3212. The marked data packets can be received by or at the radio or RF unit 3220 and processed via the marked or SSID LL circuity path 3222. The LL scheduler 3240 can prioritize processing of the marked data packets over the unmarked data packets. In other words, traffic arriving over the SSID LL is given preference over traffic arriving over SSID. In implementations, the LL scheduler 3240 may aggregate arriving data packets. In this instance, the LL scheduler 3240 can prioritize the marked data packets over the unmarked data packets. Accordingly, the LL scheduler 3240 can send and/or transmit the marked data packets to the network/Internet 3400 via the service provider system 3300 and then send and/or transmit the unmarked data packets to the network/Internet 3400 via the service provider system 3300.

Now referring also to FIG. 4, in a return and/or reverse direction, the router 3200 can receive data packets from the network/Internet 3400 via the service provider system 3300. The data packets can be processed by the router 3200, the LL scheduler 3240, and the packet analyzer or engine 3230 as described herein with respect to FIG. 3.

At any point during operation of the systems described herein, the analyzer server(s), the configuration server(s), and/or the operations support system (OSS) 3310 can provision, update, and/or configure the wireless device 3100, the packet analyzer or engine 3124, the router 3200, and/or the packet analyzer or engine 3230, as appropriate and applicable.

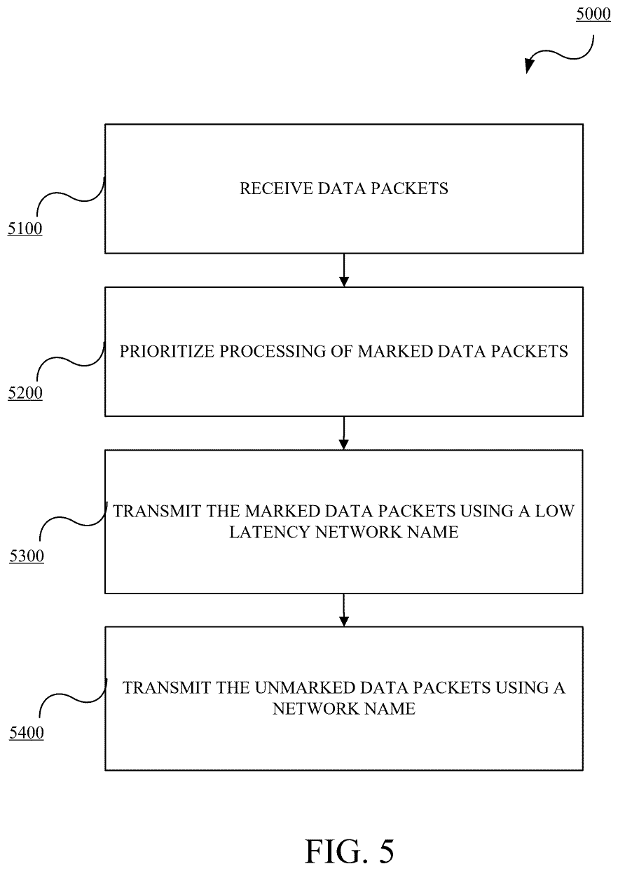

FIG. 5 is a flowchart of an example method 5000 for low latency processing in a wireless network in accordance with embodiments of this disclosure. The method 5000 includes: receiving 5100 data packets from an application on a wireless device; prioritizing 5200 processing of marked data packets in the data packets over unmarked data packets in the data packets; transmitting 5300 the processed marked data packets over a low latency wireless network name; and transmitting 5400 the processed unmarked data packets over a wireless network name. The method 5000 can be implemented, for example, in or by components described with respect to FIGS. 1-4 and 8 and in conjunction with any of the flows described with respect to FIGS. 1-4 and 6-7, as appropriate and applicable. In implementations, the method is applicable to a wireless device sending data packets to a wireless router, or a wireless router sending data packets to a wireless device.

The method 5000 includes receiving 5100 data packets from an application on a wireless device. Applications running on wireless devices can generate data packets which need to be sent to a destination device.

The method 5000 includes prioritizing 5200 processing of marked data packets in the data packets over unmarked data packets in the data packets. The data packets from some of the applications can include data packets that require low latency processing. In implementations, the applications can mark the data packets as low latency data packets (marked data packets). In implementations, the wireless device can include a packet analyzer which can determine if the data packet is a low latency data packet and mark the data packet accordingly. In implementations, marking can be done by setting a defined field in the data packet. In implementations, marking can be done by setting a defined field in an IP header of the data packet. In implementations, the defined field in the IP header can be an ECN field. A low latency engine can prioritize processing of the marked data packets. In implementations, the low latency engine can stall processing of unmarked data packets to process the marked data packets. The processing of the unmarked data packets can be restarted when processing of the marked data packets is completed. The processing of the marked data packets can include, but is not limited to, assigning resource unit blocks which are sized appropriate for the marked data packets. This can be done by the low latency engine and/or a marked circuity path associated with a low latency wireless network name. These assigned resource unit blocks can be sent substantially immediately without a requirement for throughput processing so as to minimize latency. That is, transmission of the assigned resource unit blocks are not delayed in an attempt to fill or substantially fill out the assigned resource unit blocks for purposes of maximizing throughput processing. The assigned resource unit blocks are smaller resource unit blocks versus those used for unmarked data packets. For example, the difference between the smallest RU and the largest RU can be a factor of 32. An illustrative example of resource units or blocks (RU) is shown in Table 1. The resource unit blocks assigned for or used for unmarked data packets are larger and are not sent until filled to a defined percentage. With respect to resource usage, frame aggregation or resource usage may change based on efficiency metrics. Larger frames would reduce overhead in media access but can be more prone to collisions and other interference/PHY issues. In the implementations described herein, another coupling feature can be used for resource usage. For example, in the single radio/frequency option, frame aggregation level for classic SSID (unmarked) may be adjusted dynamically based on the LL traffic queue latency or CE markings and a coupling factor that adjusts the throughput fairness. Once transmission of the unmarked data packets has started, in single radio implementations, transmission of the marked data packets need to wait until the transmission of the unmarked data packets is complete.

TABLE 1
CHANNEL BANDWIDTH

| | | | | | |
|---|---|---|---|---|---|
| RU TYPE | 20 MHz | 40 MHz | 80 MHz | 160 MHz | 320 MHz |

USER QUANTITY

| | | | | | |
|---|---|---|---|---|---|
| RU-26 | 9 | 16 | 37 | 74 | 148 |
| RU-52 | 4 | 8 | 16 | 32 | 74 |
| RU-106 | 2 | 4 | 8 | 16 | 37 |
| RU-242 | 1 | 2 | 4 | 8 | 16 |
| RU-484 | N/A | 1 | 2 | 4 | 8 |
| RU-966 | N/A | N/A | 1 | 2 | 4 |
| 2x RU-966 | N/A | N/A | N/A | 1 | 2 |
| 4x RU-966 | N/A | N/A | N/A | N/A | 1 |

The method 5000 includes transmitting 5300 the processed marked data packets over a low latency wireless network name and transmitting 5400 the processed unmarked data packets over a wireless network name. The low latency engine and/or the marked circuity path can send the marked data packets to a radio or RF unit associated with a low latency wireless network name. The low latency engine and/or an unmarked circuity path can send the unmarked data packets to a radio or RF unit associated with a wireless network name. The low latency engine can prioritize sending the processed marked data packets over the sending of the processed unmarked data packets.

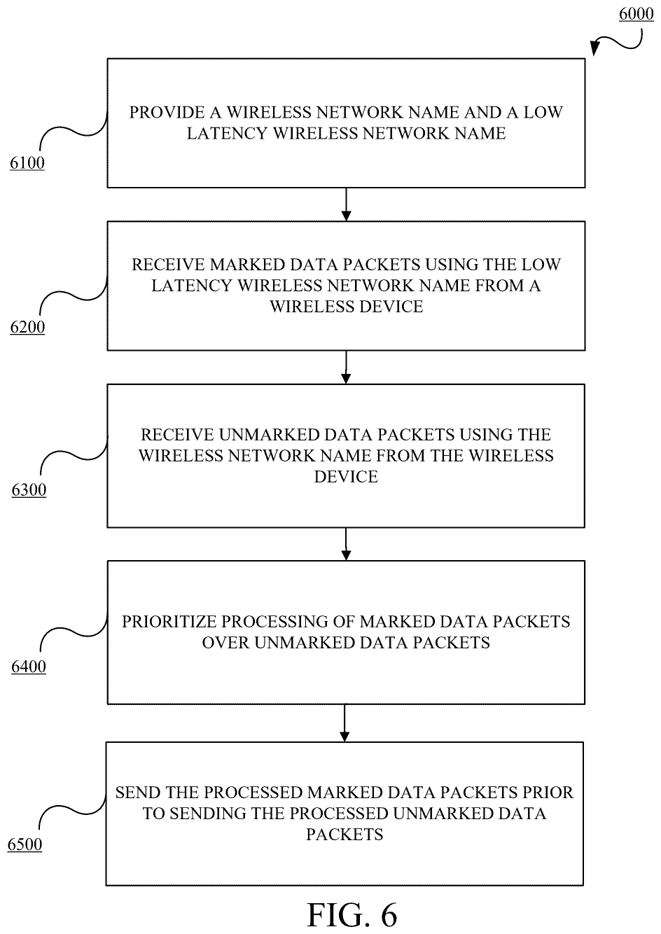

FIG. 6 is a flowchart of an example method 6000 for low latency processing in a wireless network in accordance with embodiments of this disclosure. The method 6000 includes: providing 6100 a wireless network name and a low latency wireless network name; receiving 6200 marked data packets using the low latency wireless network name from a wireless device; receiving 6300 unmarked data packets using the wireless network name from the wireless device; prioritizing 6400 processing of marked data packets over unmarked data packets; and sending 6500 the processed marked data packets prior to sending the processed unmarked data packets. The method 6000 can be implemented, for example, in or by components described with respect to FIGS. 1-4 and 8 and in conjunction with any of the flows described with respect to FIGS. 1-5 and 7, as appropriate and applicable. In implementations, the method is applicable to a wireless device sending data packets to a wireless router, or a wireless router sending data packets to a wireless device. In implementations, the wireless router and/or the wireless device can transmit and/or receive marked data packets and unmarked data packets as described herein.

The method 6000 includes providing 6100 a wireless network name and a low latency wireless network name. A router, wireless router, and/or a wireless access device (collectively referred to herein as a “wireless access device”) which provides wireless access to wireless devices at the customer premises, and supports wireless transmissions and/or communications between the wireless devices and the wireless access device, and eventually to a destination point. The wireless access device can provide two or more wireless network names or SSIDs, including one wireless network name designated for low latency data packets (low latency wireless network name) and another wireless network name for non-low latency data packets and/or classic data packets (data packets) (non-low latency wireless network name or wireless network name). In implementations, the wireless network name can be visible and the low latency wireless network name can remain hidden. In implementations, the wireless network name and the low latency wireless network name can be visible.

The method 6000 includes receiving 6200 marked data packets using the low latency wireless network name from a wireless device and receiving 6300 unmarked data packets using the wireless network name from the wireless device. The respective data packets are received over the respective two or more wireless network names. In implementations, applications can mark the data packets as low latency data packets (marked data packets). In implementations, the wireless device can include a packet analyzer which can determine if the data packet is a low latency data packet and mark the data packet accordingly. In implementations, marking can be done by setting a defined field in the data packet. In implementations, marking can be done by setting a defined field in an Internet Protocol (IP) header of the data packet. In implementations, the defined field in the IP header can be an ECN field. Transmitting of the marked data packets by the wireless device can be done using resource unit blocks which are sized appropriate for the marked data packets. This can be done by a low latency engine and/or a marked circuity path associated with a low latency wireless network name in the wireless device. These assigned resource unit blocks can be sent substantially immediately without a requirement for throughput processing so as to minimize latency. That is, transmission of the assigned resource unit blocks are not delayed in an attempt to fill or substantially fill out the assigned resource unit blocks for purposes of maximizing throughput processing. The assigned resource unit blocks are smaller resource unit blocks versus those used for unmarked data packets (see Table 1). The resource unit blocks assigned for or used for unmarked data packets are larger and are not sent until filled to a defined percentage. Once transmission of the unmarked data packets has started, in single radio implementations, transmission of the marked data packets need to wait until the transmission of the unmarked data packets is complete.

The method 6000 includes prioritizing 6400 processing of marked data packets over unmarked data packets. A low latency engine can prioritize processing of the marked data packets. In implementations, the low latency engine can stall processing of unmarked data packets to process the marked data packets. The processing of the unmarked data packets can be restarted when processing of the marked data packets is completed.

The method 6000 includes sending 6500 the processed marked data packets prior to sending the processed unmarked data packets. The low latency engine can prioritize sending of the marked data packets over sending of the unmarked data packets toward the service provider system, the network, and/or a destination.

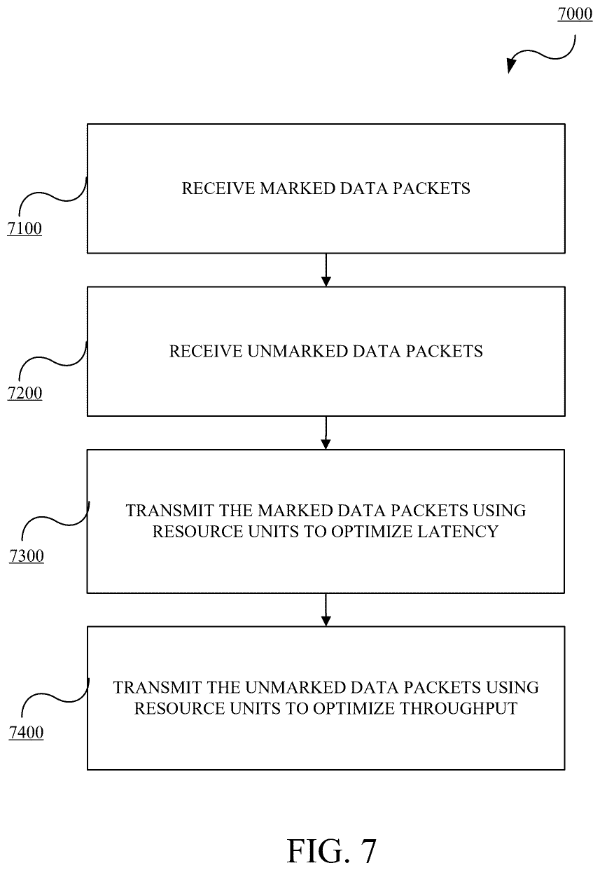

FIG. 7 is a flowchart of an example method 7000 for low latency processing in a wireless network in accordance with embodiments of this disclosure. The method 7000 includes: receiving 7100 marked data packets; receiving 7200 unmarked data packets; transmitting 7300 the marked data packets using resource units optimal for minimal latency; and transmitting 7400 the marked data packets using resource units optimal for high throughput. The method 7000 can be implemented, for example, in or by components described with respect to FIGS. 1-4 and 8 and in conjunction with any of the flows described with respect to FIGS. 1-6, as appropriate and applicable. In implementations, the method is applicable to a wireless device sending data packets to a wireless router, or a wireless router sending data packets to a wireless device. In implementations, the wireless router and/or the wireless device can transmit and/or receive marked data packets and unmarked data packets as described herein.

The method 7000 includes receiving 7100 marked data packets and receiving 7200 unmarked data packets. The marked data packets or low latency data packets can indicate data packets that are associated with low latency processing. Data packets can be marked by a content provider, an application running on a wireless device, an analyzer on the wireless device, and/or combinations thereof as described herein. In implementations, a wireless access device can provide wireless access to wireless devices at a customer premises, and support wireless transmissions and/or communications between the wireless devices and the wireless access device, and eventually to and form a destination point. The wireless access device can provide two or more wireless network names or SSIDs, including one wireless network name designated for low latency data packets (low latency wireless network name) and another wireless network name for non-low latency data packets and/or classic data packets (data packets) (non-low latency wireless network name or wireless network name). In implementations, the wireless network name can be visible and the low latency wireless network name can remain hidden. In implementations, the wireless network name and the low latency wireless network name can be visible. The respective data packets can be received over the respective two or more wireless network names.

The method 7000 includes transmitting 7300 the marked data packets using resource units optimal for minimal latency and transmitting 7400 the marked data packets using resource units optimal for high throughput. Transmitting of the marked data packets by the wireless device can be done using resource unit blocks which are sized appropriate for the marked data packets and emphasize minimal latency. This can be done by a low latency engine and/or a marked circuity path associated with a low latency wireless network name in the wireless device. Transmitting of the unmarked data packets by the wireless device can be done using resource unit blocks which are sized appropriate for the marked data packets and emphasize high throughput. This can be done by a low latency engine and/or an unmarked circuity path associated with a wireless network name in the wireless device.

In implementations using a single radio, the assigned low latency resource unit blocks can be sent substantially immediately without a requirement for throughput processing so as to minimize latency. That is, transmission of the assigned low latency resource unit blocks are not delayed in an attempt to fill or substantially fill out the assigned high throughput resource unit blocks for purposes of maximizing throughput processing. The assigned low latency resource unit blocks are smaller resource unit blocks versus the assigned high throughput resource unit blocks used for unmarked data packets (see Table 1). The assigned high throughput resource unit blocks for unmarked data packets are larger and are not sent until filled to a defined percentage. Once transmission of the unmarked data packets has started, in the single radio implementations, transmission of the marked data packets need to wait until the transmission of the unmarked data packets is complete. The low latency engine can prioritize processing of marked data packets over unmarked data packets. In implementations, the low latency engine can stall processing of unmarked data packets to process the marked data packets. The processing of the unmarked data packets can be restarted when processing of the marked data packets is completed.

In implementations using multiple radios, transmission can be done in parallel using the assigned low latency resource unit blocks and the assigned high throughput resource unit blocks as described herein.

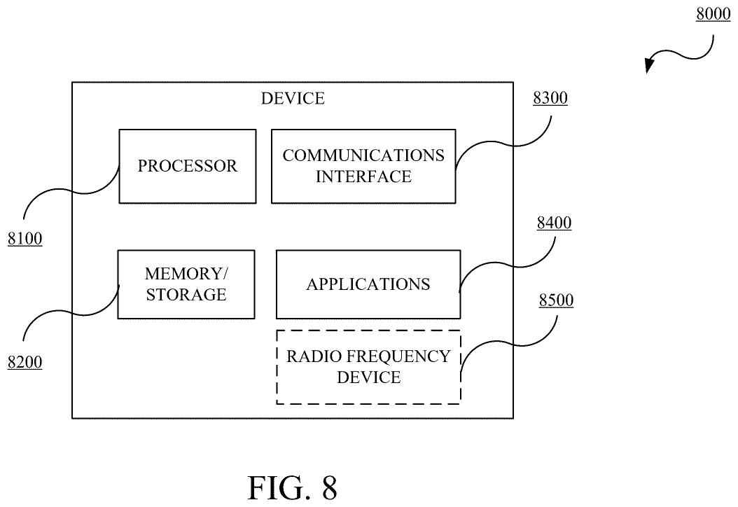

FIG. 8 is a block diagram of an example of a device 8000 in accordance with embodiments of this disclosure. The device 8000 may include, but is not limited to, a processor 8100, a memory/storage 8200, a communication interface 8300, applications 8400, and, if needed, a radio frequency device 8500. The device 8000 may include or implement, for example, the components described with respect to FIGS. 1-4 and execute the methods described with respect to FIGS. 1-7. The applicable or appropriate flows, techniques, or methods described herein may be stored in the memory/storage 8200 and executed by the processor 8100 in cooperation with the memory/storage 8200, the communications interface 8300, the applications 8400, and the radio frequency device 8500 (when applicable), as appropriate. The device 8000 may include other elements which may be desirable or necessary to implement the devices, systems, and methods described herein. However, because such elements and steps do not facilitate a better understanding of the disclosed embodiments, a discussion of such elements and steps may not be provided herein. In implementations, the wireless router and/or the wireless device can transmit and/or receive marked data packets and unmarked data packets as described herein.

Described herein are methods for enabling low latency processing in wireless networks. In implementations, a method for enabling low latency processing in wireless routers includes providing, by a wireless router, a wireless network name and a low latency wireless network name. The wireless router receiving from a wireless device, low latency data packets using the low latency wireless network name, and receiving unmarked data packets using the wireless network name. A low latency scheduler engine in the wireless router prioritizes processing of the low latency data packets over the unmarked data packets. The low latency scheduler engine and the wireless router sends the processed low latency data packets prior to sending the processed unmarked data packets.

In implementations, the low latency data packets use resource unit blocks which are used substantially immediately to minimize latency and irrespective of throughput processing. In implementations, the unmarked data packets use resource unit blocks which maximize throughput processing. In implementations, the prioritizing further includes stalling, by the low latency scheduler engine, processing of unmarked data packets to process the low latency data packets. In implementations, the low latency data packets are marked using a defined field in a data packet. In implementations, the low latency data packets are marked using a defined field in an Internet Protocol header in a data packet. In implementations, the low latency data packets are marked in using an Explicit Congestion Notification (ECN) field in an Internet Protocol header in a data packet. In implementations, the method includes receiving, by the wireless router, data packets, prioritizing, by the low latency scheduler engine, processing of low latency data packets in the data packets over unmarked data packets in the data packets, and transmitting, by the low latency scheduler engine and the wireless router, the processed low latency data packets over the low latency wireless network name prior to transmitting the processed unmarked data packets over the wireless network name. In implementations, the low latency data packets in the data packets use resource unit blocks which are used substantially immediately to minimize latency and irrespective of throughput processing and wherein the unmarked data packets use resource unit blocks which maximize throughput processing. In implementations, the low latency data packets in the data packets are marked in a defined field in a data packet. In implementations, the method further includes inspecting, by a packet analyzer in the wireless device, content in a data packet of the data packets to determine whether it is a low latency data packet. In implementations, the method further includes reviewing, by a packet analyzer in the wireless device, network information with respect to a data packet of the data packets to determine whether it is a low latency data packet. In implementations, the network information includes at least one of port numbers, data packet arrival times, data packet size, and transport protocol.

Described herein are devices and systems for enabling low latency processing in wireless networks. In implementations, a wireless access device includes a low latency service set identifier (SSID) circuit configured to transmit and receive low latency data packets, a SSID circuit configured to transmit and receive data packets, and a low latency engine connected to the low latency SSID circuit and the SSID circuit, the low latency engine configured to use resource units that minimize latency for the low latency data packets versus resource units that maximize throughput for the data packets.

In implementations, the method further includes a low latency service set identifier associated with the low latency service set identifier (SSID) circuit is hidden. In implementations, the low latency SSID circuit includes a radio circuit, and the SSID circuit includes a radio circuit. In implementations, the radio circuit of the low latency SSID circuit and the radio circuit of the SSID circuit are different. In implementations, the radio circuit of the low latency SSID circuit and the radio circuit of the SSID circuit are same and the low latency engine is further configured to prioritize processing of the low latency data packets over the data packets. In implementations, the wireless access device further includes a packet inspection engine configured to determine whether a data packet is a low latency packet. In implementations, the low latency SSID circuit includes an active queue management (AQM) component, the SSID circuit includes an AQM component, and the low latency engine includes a queue controller in a closed feedback loop with the AQM component of the low latency SSID circuit and the AQM component of the SSID circuit. The low latency engine, the queue controller, the AQM component of the low latency SSID circuit, and the AQM component of the SSID circuit configured to collectively monitor queue size and latency information to ensure a quality of service for the data packets and the low latency data packets.

Described herein are methods for enabling low latency processing in wireless networks. In implementations, a method for enabling low latency processing in wireless routers includes receiving, by a wireless router, data packets. A low latency scheduler engine and the wireless router assigns resource units for minimizing latency to low latency data packets in the data packets received from the wireless router and resource units for maximizing throughput to unmarked data packets in the data packets received from the wireless router. The low latency scheduler engine and the wireless router transmit the low latency data packets using the resource units for minimizing latency and the unmarked data packets using the resource units for maximizing throughput.

In implementations, the method further includes prioritizing, by the low latency scheduler engine, processing of the low latency data packets, where the transmitting further includes sending, by the low latency scheduler engine and the wireless router, the processed low latency data packets prior to sending the processed unmarked data packets.

Although some embodiments herein refer to methods, it will be appreciated by one skilled in the art that they may also be embodied as a system or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “processor,” “device,” or “system.” Furthermore, aspects of the present invention may take the form of a computer program product embodied in one or more the computer readable mediums having the computer readable program code embodied thereon. For example, the computer readable mediums can be non-transitory. Any combination of one or more computer readable mediums may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to CDs, DVDs, wireless, wireline, optical fiber cable, RF, etc., or any suitable combination of the foregoing.

As used herein, the term “computer-readable medium” encompasses one or more computer-readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures.

While the disclosure has been described in connection with certain embodiments, it is to be understood that the disclosure is not to be limited to the disclosed embodiments but, on the contrary, is intended to cover various modifications, combinations, and equivalent arrangements included within the scope of the appended claims, which scope is to be accorded the broadest interpretation so as to encompass all such modifications and equivalent structures as is permitted under the law.

What is claimed is:

1. A method for enabling low latency processing in wireless routers, the method comprising:
providing, by a wireless router, a wireless network name and a low latency wireless network name;
receiving, by the wireless router from a wireless device, low latency data packets using the low latency wireless network name;
receiving, by the wireless router from the wireless device, unmarked data packets using the wireless network name;
prioritizing, by a low latency scheduler engine in the wireless router, processing of the low latency data packets over the unmarked data packets; and
sending, by the wireless router, the processed low latency data packets prior to sending the processed unmarked data packets.

2. The method of claim 1, wherein the low latency data packets use resource unit blocks which are used substantially immediately to minimize latency and irrespective of throughput processing.

3. The method of claim 2, wherein the unmarked data packets use resource unit blocks which maximize throughput processing.

4. The method of claim 1, wherein the prioritizing further comprises:
stalling, by the low latency scheduler engine, processing of unmarked data packets to process the low latency data packets.

5. The method of claim 1, wherein the low latency data packets are marked using a defined field in a data packet.

6. The method of claim 1, wherein the low latency data packets are marked using a defined field in an Internet Protocol header in a data packet.

7. The method of claim 1, wherein the low latency data packets are marked in using an Explicit Congestion Notification (ECN) field in an Internet Protocol header in a data packet.

8. The method of claim 1, the method further comprising:
receiving, by the wireless router, data packets;
prioritizing, by the low latency scheduler engine, processing of low latency data packets in the data packets over unmarked data packets in the data packets; and
transmitting, by the wireless router, the processed low latency data packets over the low latency wireless network name prior to transmitting the processed unmarked data packets over the wireless network name.

9. The method of claim 8, wherein the low latency data packets in the data packets use resource unit blocks which are used substantially immediately to minimize latency and irrespective of throughput processing and wherein the unmarked data packets use resource unit blocks which maximize throughput processing.

10. The method of claim 8, wherein the low latency data packets in the data packets are marked in a defined field in a data packet.

11. The method of claim 8, further comprising:
inspecting, by a packet analyzer in the wireless device, content in a data packet of the data packets to determine whether it is a low latency data packet.

12. The method of claim 8, further comprising:
reviewing, by a packet analyzer in the wireless device, network information with respect to a data packet of the data packets to determine whether it is a low latency data packet.

13. The method of claim 12, wherein the network information includes at least one of port numbers, data packet arrival times, data packet size, and transport protocol.

14. A wireless access device, comprising:
a low latency service set identifier (SSID) circuit configured to transmit and receive low latency data packets;
a SSID circuit configured to transmit and receive data packets; and
a low latency engine connected to the low latency SSID circuit and the SSID circuit, the low latency engine configured to use resource units that minimize latency for the low latency data packets.

15. The wireless access device of claim 14, wherein a low latency service set identifier associated with the low latency service set identifier (SSID) circuit is hidden.

16. The wireless access device of claim 14, wherein:
the low latency SSID circuit includes a radio circuit; and
the SSID circuit includes a radio circuit.

17. The wireless access device of claim 16, wherein the radio circuit of the low latency SSID circuit and the radio circuit of the SSID circuit are different.

18. The wireless access device of claim 16, wherein the radio circuit of the low latency SSID circuit and the radio circuit of the SSID circuit are same and the low latency engine is further configured to prioritize processing of the low latency data packets over the data packets.

19. The wireless access device of claim 14, further comprising:
a packet inspection engine configured to determine whether a data packet is a low latency packet.

20. The wireless access device of claim 14, wherein:
the low latency SSID circuit includes an active queue management (AQM) component;
the SSID circuit includes an AQM component; and
the low latency engine includes a queue controller in a closed feedback loop with the AQM component of the low latency SSID circuit and the AQM component of the SSID circuit,
wherein the low latency engine, the queue controller, the AQM component of the low latency SSID circuit, and the AQM component of the SSID circuit configured to collectively monitor queue size and latency information to ensure a quality of service for the data packets and the low latency data packets.

21. A method for enabling low latency processing in wireless routers, the method comprising:
receiving, by a wireless router, data packets;
assigning, by a low latency scheduler engine, resource units for minimizing latency to low latency data packets in the data packets and resource units for maximizing throughput to unmarked data packets in the data packets; and
transmitting, by the wireless router, the low latency data packets using the resource units for minimizing latency and the unmarked data packets using the resource units for maximizing throughput.

22. The method of claim 21, further comprising:
prioritizing, by the low latency scheduler engine, processing of the low latency data packets, wherein the transmitting further includes:
sending, by the wireless router, the processed low latency data packets prior to sending the processed unmarked data packets.
